(19) United States
(12) Patent Application Publication
(10) Pub. No.: US 2021/0088142 A1
(43) Pub. Date: Mar. 25, 2021

(54) SEALING CONCEPT FOR AN OUTPUT SHAFT

(71) Applicant: ZF Friedrichshafen AG, Friedrichshafen (DE)

(72) Inventor: Simon Hetmaniok, Witten (DE)

(21) Appl. No.: 17/024,789

(22) Filed: Sep. 18, 2020

(30) Foreign Application Priority Data
Sep. 20, 2019 (DE) 10 2019 214 380.6

(51) Int. Cl. F16J 15/16; F16C 33/66; F16N 7/18

(52) U.S. Cl. CPC F16J 15/164; F16N 7/18; F16C 33/6666

(57) ABSTRACT

An arrangement includes a shaft, a bearing, and a structure fixed to a housing. The shaft is rotatably mounted in the structure fixed to the housing by the bearing, and a first gap extends between the shaft and the structure fixed to the housing. The bearing and the first gap are connected to each other in a lubricant-conducting manner via a cavity. The structure fixed to the housing forms a first sump for lubricant, and the first sump is configured to collect lubricant dripping from the first gap.

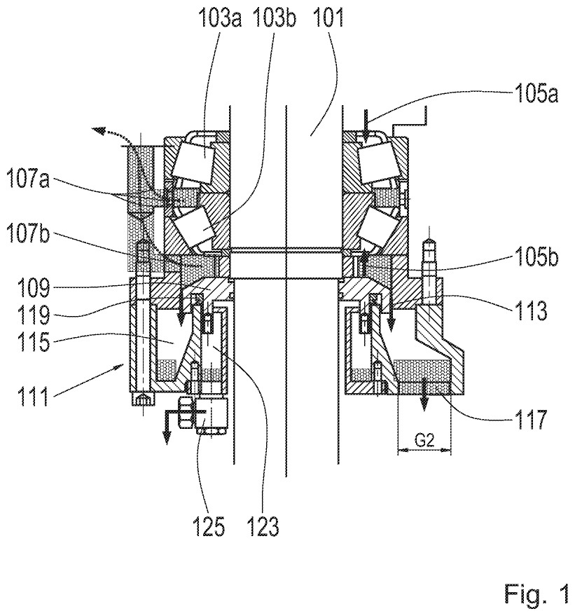

### CROSS REFERENCE TO RELATED APPLICATIONS

This application claims benefit to German Patent Application No. DE 10 2019 214 380.6, filed on Sep. 20, 2019, the entire disclosure of which is hereby incorporated by reference herein.

### FIELD

The invention relates to a sealing arrangement for a gearbox.

### BACKGROUND

Output shafts of gearboxes in a vertical installation position are usually sealed with radial shaft sealing rings. However, radial shaft sealing rings are subject to wear. This is problematic particularly in the case of gearboxes with a longer service life, for example in the case of wind turbine gearboxes or cable car gearboxes.

### SUMMARY

In an embodiment, the present invention provides an arrangement. The arrangement includes a shaft, a bearing, and a structure fixed to a housing. The shaft is rotatably mounted in the structure fixed to the housing by the bearing, and a first gap extends between the shaft and the structure fixed to the housing. The bearing and the first gap are connected to each other in a lubricant-conducting manner via a cavity. The structure fixed to the housing forms a first sump for lubricant, and the first sump is configured to collect lubricant dripping from the first gap.

### BRIEF DESCRIPTION OF THE DRAWINGS

The present invention will be described in even greater detail below based on the exemplary FIGURES. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

The FIGURE illustrates a shaft with a sealing arrangement.

### DETAILED DESCRIPTION

The present disclosure provides for improvements in the sealing of a gearbox. In particular, the tightness of the gearbox should be ensured over a longer period of time.

An arrangement according to the present disclosure has a shaft, a bearing, and a structure fixed to the housing. The shaft may be of a single- or multiple-piece design. In particular, the shaft can be an arrangement of a plurality of pieces joined together which can be rotated about a common axis of rotation and which are fixed so that they cannot rotate relative to each other.

The shaft is preferably designed as an output shaft, for example when the arrangement is a wind turbine gearbox or a part of a wind turbine gearbox. An output shaft is characterized in that it transmits an output torque of a gearbox. Accordingly, the output shaft extends through the gearbox housing. A part of the output shaft is thus located inside the gearbox housing, while another part of the output shaft is located outside the gearbox housing.

If the arrangement is, for example, a cable car gearbox or a part of a cable car gearbox, the shaft is preferably designed as an input shaft. An input shaft is characterized in that it transmits an input torque of a gearbox. Accordingly, the input shaft extends through the gearbox housing. A part of the input shaft is thus located inside the gearbox housing, while another part of the input shaft is located outside the gearbox housing.

The structure fixed to the housing is a structure which is fixed immovably relative to a gearbox housing. In particular, the structure fixed to the housing can be fixed inside the gearbox housing. The structure fixed to the housing can also be the gearbox housing itself or a part thereof.

In the structure fixed to the housing, the shaft is rotatably mounted by means of the bearing. In this case, an inner ring of the bearing is preferably fixed on the shaft or formed integrally therewith, while an outer ring of the bearing is preferably fixed in the structure fixed to the housing or is formed integrally therewith. The axis of rotation of the shaft is preferably vertical. The axis of rotation may also be at least partially vertically oriented. This means that a non-zero direction vector of the course of the axis of rotation is oriented vertically. In this case, the axis of rotation therefore is not horizontal and is inclined relative to the horizontal by an angle other than zero.

A first gap extends between the shaft and the structure fixed to the housing. The gap extends all the way around the shaft or its axis of rotation and is uninterrupted. The gap is preferably rotationally symmetrical with respect to the axis of rotation. The gap forms a constriction with respect to the lubricant with which the bearing is lubricated. As a result, the gap acts as a contactless seal for the bearing. It can be a simple, approximately cylindrical gap or a gap designed as a labyrinth seal.

In particular when the shaft is installed vertically, lubricant leaks, which lead to lubricant escaping through the gap, cannot be excluded. According to the present disclosure, a multi-stage sealing system is therefore provided. According to the present disclosure, a first sealing stage formed by the gap is supplemented by a second sealing stage which is effected by a first sump. “Sump” refers to a trough-shaped structure for collecting and temporarily storing a liquid, for example lubricant. In the present case, the structure fixed to the housing forms the first sump.

The first sump is designed to collect lubricant dripping from the first gap. The first gap and the first sump are arranged relative to one another in such a way that lubricant can drip from the first gap into the first sump. The lubricant, which drips from the first gap, passes directly into the first sump, in particular without coming into contact with further gearbox components. On the way from the first gap into the first sump, the dripping lubricant is therefore in free fall.

Since the first gap extends all the way around the shaft or the axis of rotation, the first sump also extends all the way around the shaft or the axis of rotation. At least a part of the interior of the first sump is a toroid whose central axis is identical to the axis of rotation of the shaft.

The first sump prevents lubricant that is dripping from the first gap from getting outside the gearbox. In particular, there is no need for shaft sealing rings susceptible to wear. The multi-stage structure of the sealing concept also enables leakage-free sealing of the shaft.

The arrangement according to the present disclosure is particularly advantageously used when the gap is located below the bearing. The result of such an arrangement is that lubricant collects above the gap. Since the gap acts as a contactless seal, it is not possible to prevent a small amount of the lubricant from passing through the gap. This lubricant does not leak into the environment but is collected by the first sump.

In order that the first sump does not overflow, it is provided with an outlet in a preferred development. The outlet is preferably located at the bottom of the first sump. The lubricant collected by the first sump can flow out through the outlet.

In a preferred development, the structure fixed to the housing forms a second sump in addition to the first sump. Like the first sump, this second sump extends all the way round the axis of rotation of the shaft. Preferably, at least a part of the interior of the second sump is designed as a toroid whose central axis is identical to the axis of rotation of the shaft.

Since the shaft is rotatable relative to the structure fixed to the housing and thus relative to the first sump, a second gap extends between the first sump and the shaft. This second gap is preferably rotationally symmetrical with respect to the axis of rotation of the shaft. In order to ensure that, even under adverse circumstances, no lubricant can escape through this gap, the second sump acts according to a development as a third sealing stage. This means that the second sump is designed to collect lubricant escaping through the second gap. The lubricant escaping through the second gap is collected in the interior of the second sump.

The risk of lubricant escaping is further minimized if the arrangement is developed with a seal that seals the second gap. This seal may be a contact seal, such as a V-ring.

In order to discharge the lubricant collected in the interior of the second sump, the second sump is also preferably developed with an outlet.

In a preferred development, at least a part of the second sump is arranged between the shaft and the first sump. This means that at least one plane extending radially, that is to say orthogonally to the axis of rotation of the shaft, intersects both sumps, thereby allowing the second sump to be attached below the second gap.

The FIGURE illustrates a shaft with a sealing arrangement.

The shaft 101 shown in the FIGURE is rotatably mounted by means of two tapered roller bearings 103a, 103b. The tapered roller bearings 103a, 103b are arranged in an X configuration and form a fixed bearing for the shaft 101.

Oil is supplied to the tapered roller bearings 103a, 103b by means of injection lubrication 105. In order to discharge the oil from the bearings 103a, 103b, return channels 107a, 107b are provided.

The axis of rotation of the shaft 101 is vertical. Oil therefore collects below the bearings 103a, 103b. At this point, a gap 113 extends between a ring 109 fixed on the shaft 101 and a structure 111 fixed to the housing. The gap 113 acts as a gap seal. This gap seal is impermeable to the majority of the oil accumulated below the bearings 103a, 103b. However, it is not possible to prevent a small portion of the oil from passing through the gap 113. This oil is collected in a first sump 115 formed by the structure 111 fixed to the housing. The oil is discharged from the first sump 115 via an outlet 117.

A V-ring 119 seals a gap extending between the first sump 115 and the ring 109. Under normal operating conditions, oil cannot escape through the V-ring 119. In order to also prevent oil escaping at this point from reaching the environment in the event of a fault, a second sump 123 is arranged below the V-ring 119. The second sump 123 is screwed to the first sump 115. Oil that has passed through the V-ring 119 and collected in the second sump 123 is discharged via an outlet 125.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

101 Shaft

103a Tapered roller bearing

103b Tapered roller bearing

105 Injection lubrication

107a Return channel

107b Return channel

109 Ring

111 Structure fixed to the housing

113 Gap

115 First sump

117 Outlet

119 V-ring

123 Second sump

125 Outlet

What is claimed is:

1. An arrangement, comprising:
a shaft;
a bearing; and
a structure fixed to a housing;
wherein the shaft is rotatably mounted in the structure fixed to the housing by the bearing,
wherein a first gap extends between the shaft and the structure fixed to the housing,
wherein the bearing and the first gap are connected to each other in a lubricant-conducting manner via a cavity,
wherein the structure fixed to the housing forms a first sump for lubricant, and
wherein the first sump is configured to collect lubricant dripping from the first gap.

2. The arrangement according to claim 1, wherein the first sump has an outlet.

3. The arrangement according to claim 1, wherein the structure fixed to the housing forms a second sump, wherein a second gap extends between the first sump and the shaft, wherein the second sump is configured to collect lubricant escaping through the second gap.

4. The arrangement according to the claim 3, further comprising a seal configured to seal the second gap.

5. The arrangement according to claim 3, wherein the second sump has an outlet.

6. The arrangement according to claim 3; wherein at least a part of the second sump is arranged between the shaft and the first sump.
